(19) United States
(12) Patent Application Publication
(10) Pub. No.: US 2013/0049757 A1
(43) Pub. Date: Feb. 28, 2013

(54) Device and Method for Detecting an Underground Power Line

(71) Applicants: Christoph Wuersch, Werdenberg (CH); Dietmar Schoenbeck, Goefis (AT); Sascha Korl, Buchs (CH); Patrick Haldner, Schaan (LI)

(72) Inventors: Christoph Wuersch, Werdenberg (CH); Dietmar Schoenbeck, Goefis (AT); Sascha Korl, Buchs (CH); Patrick Haldner, Schaan (LI)

(21) Appl. No.: 13/550,283

(22) Filed: Jul. 16, 2012

(30) Foreign Application Priority Data
Jul. 15, 2011 (DE) 102011079261.9

(51) Int. Cl. G01V 3/11

(52) U.S. Cl. 324/326

(57) ABSTRACT

A device for detecting an underground power line includes, for example, a sensor unit that has a magnetic field sensor element that is configured for receiving a received signal depending on the features of the power line and the underground, a control and evaluation unit configured for controlling the sensor unit and for evaluating the received signal, and a display unit for displaying the received signal evaluated by the control and evaluation unit. The sensor unit includes, for example, at least one additional magnetic field sensor element configured to receive a received signal depending on the features of the power line and the underground, wherein the magnetic field sensor elements can be independently controlled by the control and evaluation unit.

### CROSS REFERENCE TO RELATED APPLICATIONS

The present application claims priority to German Patent Application DE 10 2011 079 261.9, filed Jul. 15, 2011, which is hereby incorporated by reference in its entirety.

### TECHNICAL FIELD

The present invention relates to devices and methods for detecting an underground power line.

Typical objects, which are detected underground, include, for example, water pipes, rebar, electric and power lines, accumulations of moisture, and hollow spaces. The term “object” within the scope of this patent application includes, for example, arbitrary solid, liquid, and gaseous objects embedded underground. A need exists for power lines to be detected with high reliability by a detection device, due to the risk of accidents when severing a power line. A power line is defined as an electric line with a current flowing, which during operation generates a magnetic field that can be used for detecting the power line. Although telephone and antenna cables represent electric lines, they only carry very low currents and need not be included in the definition of the term “power line” as used within the scope of this application.

### BACKGROUND OF THE INVENTION

Prior art devices for detecting an underground power line include a sensor unit with a magnetic field sensor element, which is embodied as a coil or another magnetic field sensor (e.g., semiconductor magnetic field sensor, fluxgate sensor, magneto-impedance sensor), a control and evaluation unit, and a display unit. The display unit is an LED display unit or a signal strength display unit.

A disadvantage of prior art detection devices includes that the spatial arrangement of the underground power line is not illustrated realistically for the user. The spatial arrangement of the underground power line is deduced by the user by a repeated scanning of the power line and marked on the underground.

### SUMMARY OF THE INVENTION

An objective of the present invention includes further developing a device and a method for detecting an underground power line of the type mentioned at the outset such that the progression of the underground power line is visualized realistically for the user.

In one embodiment, a device for detecting a power line in the underground includes a sensor unit, a control and processing unit and a display unit. The sensor unit includes a magnetic field sensor element that is configured to receive a received signal based on the characteristics of the power line and the underground. The control and processing unit is configured to control the sensor unit and to process the received signal. A display unit is configured to display the received signal processed by the control and processing unit. The sensor unit includes at least one additional magnetic field sensor unit configured to receive the received signal dependent on the characteristics of the power line and the underground, in which the magnetic field sensor elements are configured to be controlled independently by the control and processing unit.

In another embodiment, the device for detecting an underground power line is characterized according to the invention such that the sensor unit includes at least one additional magnetic field sensor element, which is configured to receive a received signal dependent on the features of the underground power line, with the magnetic field sensor elements being independently controlled by the control and evaluation unit. An arrangement of several magnetic field sensor elements is useful in that the spatial arrangement of the underground power line can be determined and displayed on the display unit. The magnetic field sensor elements record a magnetic field or a magnetic field gradient as the received signals.

Suitable magnetic field sensor elements include, for example, coils, echo sensors, magneto-impedance sensors, magneto-inductive sensors, fluxgate sensors, giant magneto resonance sensors, colossal magneto resistance sensors, and anisotropic magneto resistance sensors, as well as all other sensors suitable for detecting magnetic fields.

In one embodiment, the sensor unit includes first and second magnetic field sensor elements. The first magnetic field sensor elements detects a magnetic field or a magnetic field gradient in a first direction and the second magnetic field sensor elements detects a magnetic field or a magnetic field gradient in a second direction, which is different from the first direction. The second direction can be aligned perpendicular with respect to the first direction.

In another embodiment, the first and second magnetic field sensor elements are arranged alternatingly along a horizontal direction. By the alternating arrangement along a horizontal direction, the number of magnetic field sensor elements used to determine the spatial progression of an underground power line can be reduced. An average amount is calculated from the measurements of adjacent magnetic field sensor elements. A number N of first and second magnetic field sensor elements yields N−1 measurements. This type of alternating arrangement is primarily suitable for expensive magnetic field sensor elements. 2N−2 magnetic field sensor elements are configured for magnetic field sensor elements measuring a magnetic field in the first and second direction at the same position.

In yet another embodiment, the sensor unit shows third magnetic field sensor elements, which detect a magnetic field or a magnetic field gradient in a third direction different from the first and second directions. The third direction is aligned in a direction perpendicular with respect to the first and second directions. Due to the fact that the magnetic field or the magnetic field gradient of the power line is detected in a third direction the reliability of the measurement and the precision of the spatial allocation of the underground power line is improved, primarily in case of inclined, curvy, and/or twisted power lines and in multi-phase power lines.

In another embodiment, the magnetic field sensor elements detect a magnetic field or a magnetic field gradient in a first direction and in a second direction, which is different from the first direction. The magnetic field sensor elements detect a magnetic field or a magnetic field gradient in a third direction, which is different from the first and the second directions. Small, cost-effective magnetic field sensors (e.g., echo elements) are suitable as magnetic field sensor elements detecting the magnetic field or the magnetic field gradient of the power line in two and/or three directions.

In one embodiment, the magnetic field sensor elements each include two magnetic field sensors, which are arranged parallel and at a distance in reference to each other. Due to the parallel arrangement of two magnetic field sensors a difference can be calculated between the measurements of the magnetic field sensors. Due to the formation of the difference, homogenous magnetic unidirectional fields interfering with the measurements are eliminated, and the reliability and the precision of the measurement are improved.

In another embodiment, a modulation unit is provided, which can be connected, via a communication connection, to the control and evaluation unit and which, upon an order by the control and evaluation unit, modulates a power signal of the power line. By the modulation of the power signal with a known pattern, for example, the received signals of the power line can be better identified by the magnetic field sensor elements. The modulation unit is configured, for example, such that it is plugged into an outlet provided in the underground and coupled to a phase of the power line. The control and evaluation unit includes an evaluation module for demodulating the received signals.

In one embodiment, another sensor unit is provided to detect an underground object. The additional sensor unit to be embodied as an inductive sensor unit, capacitive sensor unit, radar sensor unit, magnetic field sensor unit, or another sensor unit suitable to detect underground objects. Depending on the field of application of the detection device all known sensor units may be combined with each other.

Power lines are detected with a high degree of reliability by a detection unit due to the risk of accidents when a power line is severed. When using several sensor units with different sensor features, the quality and reliability of the measurement can be increased. The additional sensor unit includes several sensor elements differing in at least one sensor feature from the magnetic field sensor elements. The term “sensor features” summarizes any and all features of sensor units, such as type of sensor, size, position, alignment. The combination of a sensor unit for detecting arbitrary underground objects with a sensor unit for detecting an underground power line is useful in that power lines are detected by both sensor units and the reliability of the measurement and the precision can be increased for the spatial allocation of the power line. Using the sensor unit for detecting arbitrary objects allows primarily the determination of the spatial alignment of underground objects and by using the sensor unit for detecting a power line it can be ensured that power lines are securely detected.

In one embodiment, a method for detecting a power line in an underground is provided. The method may include, for example, one or more of the following: detecting a received signal by a magnetic field sensor of a sensor unit; evaluating the received signal by a control and evaluation unit; displaying the evaluated received signals on a display unit; and detecting at least one additional received signal by another magnetic field sensor element of the sensor unit.

In another embodiment, the method for detecting an underground power line can include an additional step of detecting at least one further received signal by another magnetic field sensor element of the sensor unit. Due to the fact that several received signals are detected by the magnetic field sensor elements a horizontal illustration can be determined representing the progression of the underground power line.

In one embodiment, a first magnetic field gradient is detected in a first direction and a second magnetic field gradient in a second direction. The first and the second direction can be arranged perpendicularly with respect to each other. In one embodiment, as the sensor unit is moved in the travel direction over the underground, the first magnetic field gradient is detected in a horizontal direction perpendicular with respect to the travel direction, and the second magnetic field gradient is detected in the travel direction, and in a depth direction perpendicular to the horizontal direction. The progression of a power line can be determined in the underground from the magnetic field gradients in the horizontal direction and the depth direction.

In another embodiment, the first and second magnetic field sensor elements are arranged alternatingly in the horizontal direction and from the first magnetic field gradient and the second magnetic field gradient an average amount can each be calculated from adjacent first and second magnetic field sensor elements. By the alternating arrangement of the magnetic field sensor elements along the horizontal direction the number of the magnetic field sensor elements is reduced which is used to determine the spatial progression of an underground power line.

Based on the average amounts of the adjacent first and second magnetic field sensor elements, a horizontal illustration is calculated by the control and evaluation unit, the horizontal illustration is transmitted by the control and evaluation unit to a display unit, and displayed on the display unit. From the horizontal illustration the user is provided with a spatial impression of where the power line extends in the underground.

In one embodiment, additional received signals are received by the sensor elements of another sensor unit. By the use of different sensor types or the use of a sensor type with different sensor features different objects or objects at different depths in the underground are reliably detected.

In another embodiment, using the control and evaluation unit, joint depth cross sections and from the joint depth cross sections a joint top view are calculated from the received signals of the sensor unit and the received signals of the additional sensor unit. Joint depth cross sections and a joint top view are useful such that all objects are displayed in one illustration. Additionally, the reliability during the detection of a type of object is increased when the type of object has been detected by different manners.

In yet another embodiment, the control and evaluation unit calculates from the received signal of the sensor unit and the received signal of the additional sensor unit separate depth cross sections and from the separate depth cross section separate top views. Separate depth cross sections and a separate top view are useful in allowing the adjusting of the display and calculation parameters for the depth cross sections and the top view to the depth range and the objects to be detected.

### BRIEF DESCRIPTION OF THE DRAWINGS

FIG. 1 shows the application of a detection device according to the invention in an interior space, including a concrete floor with an embedded iron grating and a masonry rear wall made from brick with horizontally and vertically extending electric lines.

FIG. 2A shows a top view of a first embodiment of a manually guided detection device according to the invention. The top view of the detection device faces away from the underground to be detected.

FIG. 2B shows a bottom view, facing the underground to be detected, of the detection device shown in FIG. 2A. A measuring device is arranged inside with a first sensor unit and a second sensor unit.

FIG. 3A shows a power sensor unit from FIG. 2B.

FIG. 3B shows a first magnetic field sensor element of the power sensor unit in FIG. 3A.

FIG. 3C shows a second magnetic field sensor element of the power sensor unit of FIG. 3A.

FIG. 4 shows another embodiment of a magnetic field sensor element of the power sensor unit from FIG. 2B.

FIG. 5 shows a display of a measurement of the detection device of FIGS. 2A-B, which is moved along a travel direction over the underground to be detected. The display of the measurement includes a top view and a depth cross section view.

FIG. 6 shows another embodiment of a power sensor unit with a first sensor unit and a second sensor unit aligned in two horizontal directions perpendicular with respect to each other.

### DETAILED DESCRIPTION OF THE INVENTION

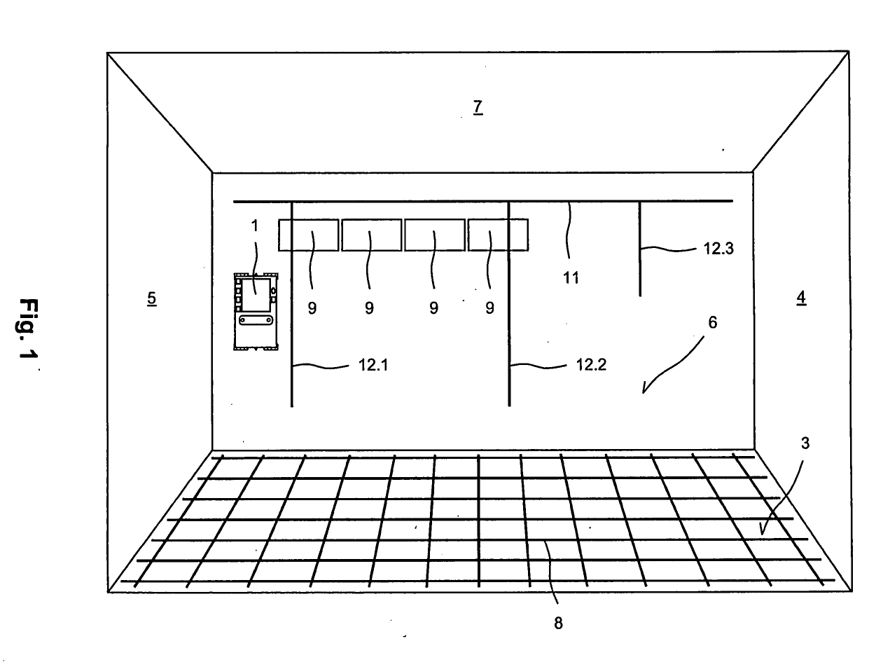

FIG. 1 shows the application of a device 1 according to the invention for detecting a power line in an interior space 2. The detection device 1 is embodied as a hand-held or guided detection device. A hand-held detection device is held over the underground to be detected without any driving device and a guided detection device is guided along a linear track or an arbitrary track over an underground to be detected. Detection devices are called hand-held and/or hand-guided when a user manually guides or holds it over the underground to be detected.

The interior space 2 includes a floor 3, a right and left lateral wall 4, 5, a rear wall 6, and a ceiling 7. The bottom 3 includes a concrete slab with an embedded iron grating 8. The rear wall 6 is made from cinder blocks and/or bricks 9. A horizontally arranged power line 11 extends in the rear wall 7 and three vertically arranged power lines 12.1, 12.2, 12.3, branch off the horizontally arranged power line 11.

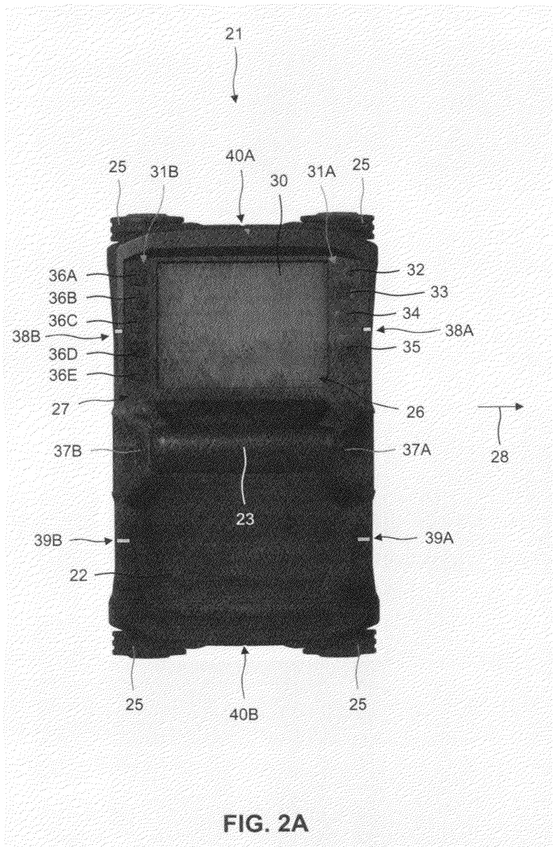

FIG. 2A shows a first embodiment of a hand-held detection device 21, including a housing 22, a handle 23, a motion unit 24 with four wheels 25, a display unit 26, and an operating unit 27.

The user guides the detection device 21 with the help of the handle 23 and the motion device 24 in a travel direction 28 over the underground to be detected, for example, embodied as the floor 3 or the rear wall 6. The handle 23 is arranged on a top 29 of the detection device 21 facing away from the underground 3, 6 during the measurement and connected with the housing 22. The display unit 26 includes a display 30, on which the measurements of the detection device 21 are displayed as a measurement.

The operating unit 27 serves to start the measurement and to adjust the detection device 21. The operating unit 27 includes a first and second operating unit 31A, 31B, which are arranged on the top 29 in addition to the display 30. The first operating unit 31A includes an on/off switch 32 to activate and deactivate the detection device 21, a toggle switch 33 by which a marker line or a marker cross is positioned in an illustration on the display 30 and can be displaced, as well as two additional operating buttons 34, 35. The second operating unit 31B includes five functional controls 36A-36E for activating different functions of a functions menu, shown on the display 30. The operating unit 27 additionally includes two start/stop buttons 37A, 37B serving to start and stop a measurement and arranged at the handle 23.

The detection field of the detection device 21 is limited and does not coincide with the full length of the housing 22. The limit of the detection field is displayed at the right housing edge of the housing 22 via an upper and lower right marker 38A, 39A and the left housing edge via an upper and lower left marker 38B, 39B. Using the markers the operator can place the detection device 21 on the underground to be detected. The center of the detection field is displayed at the upper and lower housing edge via an upper and lower marker 40A, 40B.

FIG. 2B shows the detection device 21 in a view of the bottom 42, facing an underground during measuring. A measuring device 43 is located inside the housing 22 at the bottom 42. The measuring device 43 includes a first sensor unit 44, a second sensor unit 45, a control and evaluation unit 46, a power source 47, and a coordinates detection unit 48.

The control and evaluation unit 46 serves to control the first and second sensor unit 44, 45 to evaluate the received signals provided by the sensor units 44, 45 and to display the measurements in the form of a measurement image on the display unit 26. The control and evaluation unit 46 is connected via real-time communication connections to the first and second sensor unit 44, 45 and via another real-time communication connection to the display unit 26. The term “real-time communication connection” also includes, in addition to communication connections without any time lags, communication connections, in which the time lag between the detection of the received signal by the sensor unit and the display of the measurements on the display unit 26 is so short that the measurements are displayed on the display unit 26 essentially at the present position of the sensor unit. The power source 47 is connected to the first sensor unit 44, the second sensor unit 45, the control and evaluation unit 46, and the display unit 26, and provides the units 44, 45, 46, 26 with the electric energy used for the measuring operation.

The detection device 21 is moved during the measuring process in a travel direction 28 with the travel speed over the underground to be detected. The coordinate detection unit 48 detects the coordinates in a travel direction 28. In a guided detection device by which an arbitrary motion can be performed the coordinates are detected by the coordinates detection device in a level parallel with respect to the bottom of the housing 22.

The first sensor unit 44 is embodied as a magnetic field sensor unit for detecting a power line and is also called a power sensor unit. The second sensor unit 45 is embodied as a sensor unit for detecting an arbitrary object in the underground and includes a first sensor element 49.1, a second sensor element 49.2, and a third sensor element 49.3. The sensor elements 49.1-49.3 are embodied as inductive sensors, capacitive sensors, radar sensors, magnetic field sensors, or as other sensors suitable for detecting underground objects and arranged nested in two rows. The power sensor unit 44 is arranged between the first row of the sensor elements 49.1, 49.2 and the housing 22 of the detection device 21.

In the embodiment of FIG. 2B the sensor elements 49.1-49.3 are embodied as radar sensor elements. The radar sensor elements 49.1-49.3 are controlled during the measuring operation via the control and evaluation unit 46 such that in the transmission mode at any given time only one radar sensor element transmits a transmission signal and in the receiving mode all radar sensor elements 49.1-49.3 simultaneously receive a received signal. In another first partial measuring step the first radar sensor element 49.1 transmits a first transmission signal and the three radar sensor elements 49.1-49.3 respectively receive a received signal. In a second partial measuring step the second radar sensor element 49.2 transmits a second transmission signal and the three radar sensor elements 49.1-49.3 each receive a received signal. In a third partial measuring step the third radar sensor element 49.3 transmits a third transmission signal and the three radar sensor elements 49.1-49.3 each receive a received signal.

The nine received signals of a measuring step include three mono-static and six bi-static received signals, with mono-static referring to a mode in which the sensor element transmits and simultaneously receives, and bi-static to a mode in which a sensor element transmits and another sensor element receives. The nine received signals are allocated in the XY-level to three mono-static and three bi-static area sections. Each sensor element 49.1-49.3 is allocated to a mono-static area section, at which the allocated mono-static received signal is illustrated. The bi-static received signals of the first and second sensor elements 49.1, 49.2 are averaged and the averaged signal is allocated to a first bi-static area section, which is arranged between the first and second mono-static area section. Similarly, the bi-static received signals of the first and third sensor elements 49.1, 49.3 and/or the second and third sensor elements 49.2, 49.3 are averaged, and the averaged signals are allocated to a second and third bi-static area section, with the second bi-static area section being arranged between the first and third mono-static area section and the third bi-static area section between the second and third mono-static area section. In addition to forming averages, for example a median, a maximum value, or a weighed total can be calculated from the received bi-static signals. The term “averaged signal” is understood as a signal which is calculated by a suitable mathematical function from the received bi- static signals.

The six area sections which are moved with the travel speed along the travel direction 28 form five receiving channels in the first horizontal direction. During the travel motion the received signals are detected and from the detected received signals a portion of the depth cross section is already calculated. This part of the depth cross section is transmitted from the control and evaluation unit 46 via the real-time communication connection to the display unit 26. The depth cross section is regularly updated during the travel motion. The receiving channels form the lanes showing the received signals and are regularly updated.

In order to increase the reliability when detecting a power line and ensure that the received signal is actually generated by a power line present in the underground the power sensor unit 44 includes a modulation unit 50 for modulating a power signal. The modulation unit 50 can be connected via a communication connection 51 to the control and evaluation unit 46 and is for example embodied such that it is plugged into an outlet, present in the underground, and is coupled to a phase of the power line. The control and evaluation unit 46 transmits a control command via a communication connection 51 to the modulation unit 50, modulating the power signal with a predetermined pattern. In order to evaluate the received signals the control and evaluation unit 46 includes a respective evaluation module for demodulating the received signal.

The measuring device 43 shown in FIG. 2B includes two sensor units 44, 45 differing from each other in at least one sensor feature. The detection device 21 can also be operated with only a single power sensor unit 44. By using several sensor units with different sensor features the quality and reliability of the measurement can be increased.

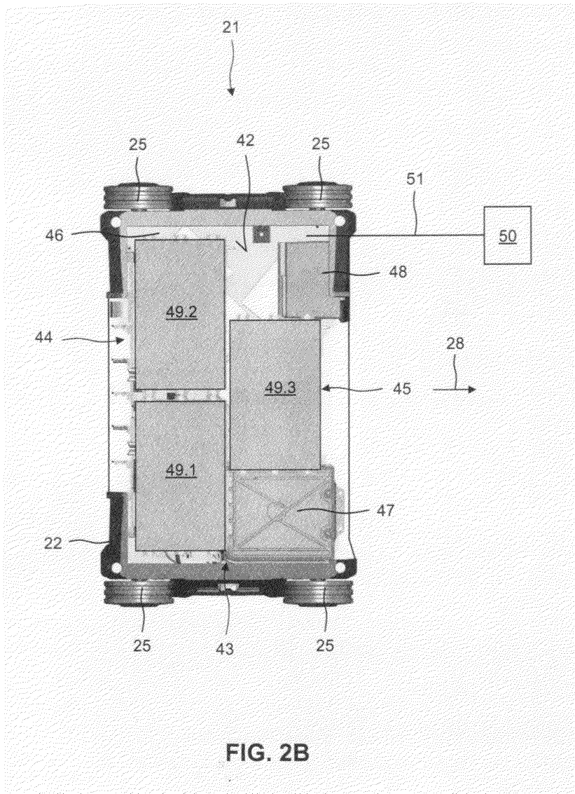

FIG. 3A shows the power sensor unit 44 of the detection device 21 in an enlarged illustration. The power sensor unit 44 includes four first magnetic field sensor elements 61.1, 61.2, 61.3, 61.4 and three second magnetic field sensor elements 62.1, 62.2, 62.3, fastened alternating on a circuit board 63.

The circuit board 63 serves as a fastening element for the mechanic fastening and for an electric connection for the first and second magnetic field sensor elements 61.1-61.4, 62.1-62.3. A connection element 64 is provided on the circuit board 63, by which the circuit board 63 can be connected to a control and evaluation unit 46. The first and second magnetic field sensor elements 61.1-61.4, 62.1-62.3 are aligned in two horizontal directions 65, 66 perpendicular in reference to each other. The depth direction 67 is defined as the direction into the underground perpendicular in reference to the horizontal directions 65, 66.

FIG. 3B shows the first magnetic field sensor element 61 of the power sensor unit 44 in detail. The first magnetic field sensor element 61 includes a circuit board section 68, a first pair of magnetic field sensors 69A, 69B, and an amplifier 70. The magnetic field sensors 69A, 69B are shaped as coils in the embodiment of FIG. 3A and aligned along the second horizontal direction 66. The magnetic field sensors 69A, 69B are aligned parallel and distanced with respect to each other in the depth direction 67 and measure a magnetic alternating field B_{x,A}, B_{x,B} (e.g., 50/60 Hz) in a first horizontal direction 65.

FIG. 3C shows the second magnetic field sensor element 62 of the power sensor unit 44 in detail. The second magnetic field sensor element 62 includes a circuit board section 71, a second pair of magnetic field sensors 72A, 72B, and an amplifier 73. The magnetic field sensors 72A, 72B are shaped as coils in the embodiment of FIG. 3A and aligned along the depth direction 67. The magnetic field sensors 72A, 72B are in parallel with respect to each other, arranged distanced in a second horizontal direction 66, and measure a magnetic alternating field B_{z,A}, B_{z,B} (e.g., 50/60 Hz) in the depth direction 67.

In order to eliminate a homogenous magnetic unidirectional field (homogenous alternating field) during the detection, a difference value ΔBₓ=B_{x,A}−B_{x,B} is calculated between the magnetic field sensors 69A, 69B of the first pair and a difference value ΔB_{z}=B_{z,A}−B_{z,B} between the magnetic field sensors 72A, 72B of the second pair. From the difference values ΔBₓ, ΔB_{z} of the adjacent first and second pairs of magnetic field sensors 61.1-61.4, 62.1-62.3 an average ΔB_{xz}=sqrt[(ΔBₓ)²+(ΔB_{z})²] is calculated. The power sensor unit 44 shown in FIG. 3B with four first magnetic field sensor elements 61.1-61.4 and three second magnetic field sensor elements 62.1-62.3 yields six measurements ΔB_{xz,1}−ΔB_{xz,6}, which are allocated to six different X-coordinates along the first horizontal direction 65. The control and evaluation unit 46 calculates from the measurements ΔB_{xz,1}−ΔB_{xz,6} the progression of the power line in the underground and transmits a horizontal illustration (XY-illustration) of the underground with the power line to the display unit 26.

From the detection device 21 of FIG. 2B with the first and second sensor elements 44, 45 the first and second magnetic field sensor elements 61.1-61.4, 62.1-62.3 are arranged alternating along the first horizontal direction 65 and detect a measuring zone in the first horizontal direction 65 which is equivalent to the detection field of the second sensor unit 45. The measurements of the first and second sensor unit 44, 45 may be shown as separate measurements or in a combined measurement.

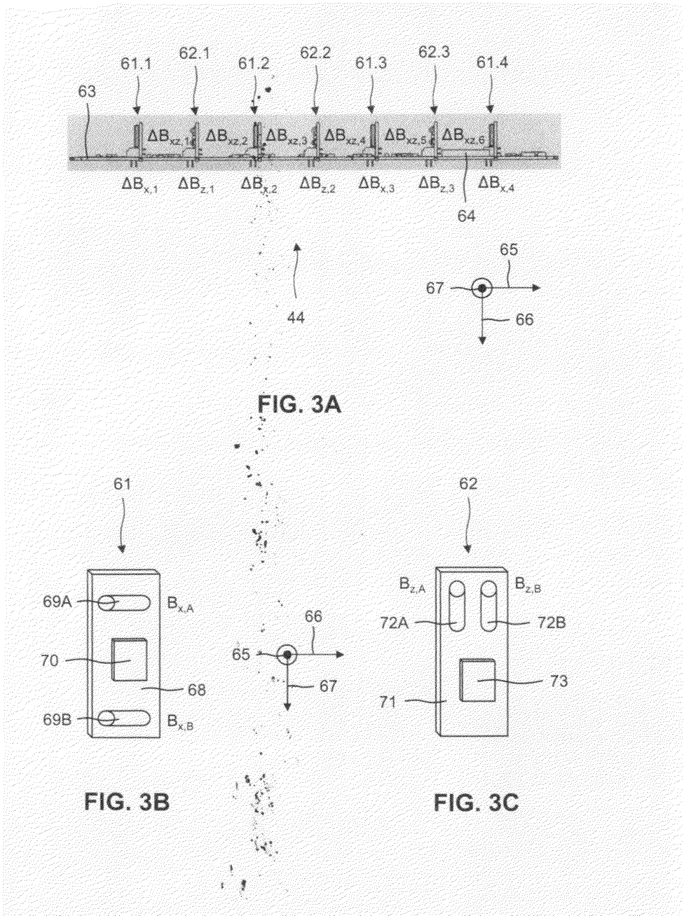

FIG. 4 shows an alternative embodiment of the magnetic field sensor element 81, which replaces the first and second magnetic field sensor elements 61.1-61.4, 62.1-62.3 in the power sensor unit 44 of FIG. 3A. In this case the power sensor unit 44 includes seven identically designed magnetic field sensor elements 81 arranged side-by-side on the circuit board 63. The magnetic field sensor element 81 includes a circuit board section 82, a first pair of magnetic field sensors 83A, 83B, a second pair of magnetic field sensors 84A, 84B, as well as a first amplifier 85 for the first sensor pair 83A, 83B, and a second amplifier 86 for the second sensor pair 84A, 84B.

The magnetic field sensors 83A, 83B, 84A, 84B are embodied as coils. The first pair of coils 83A, 83B is arranged in parallel with respect to each other, along the second horizontal direction 66, and the coils 83A, 83B are arranged distanced from each other in the depth direction 67. The second pair of coils 84A, 84B is arranged in parallel with respect to each other, aligned along the depth direction 67, and the coils 84A, 84B are arranged distanced from each other in the second horizontal direction 66. The first pair of coils 83A, 83B measures a first difference in the first horizontal direction 65 and the second pair of coils 84A, 84B measures a second difference in the depth direction 67.

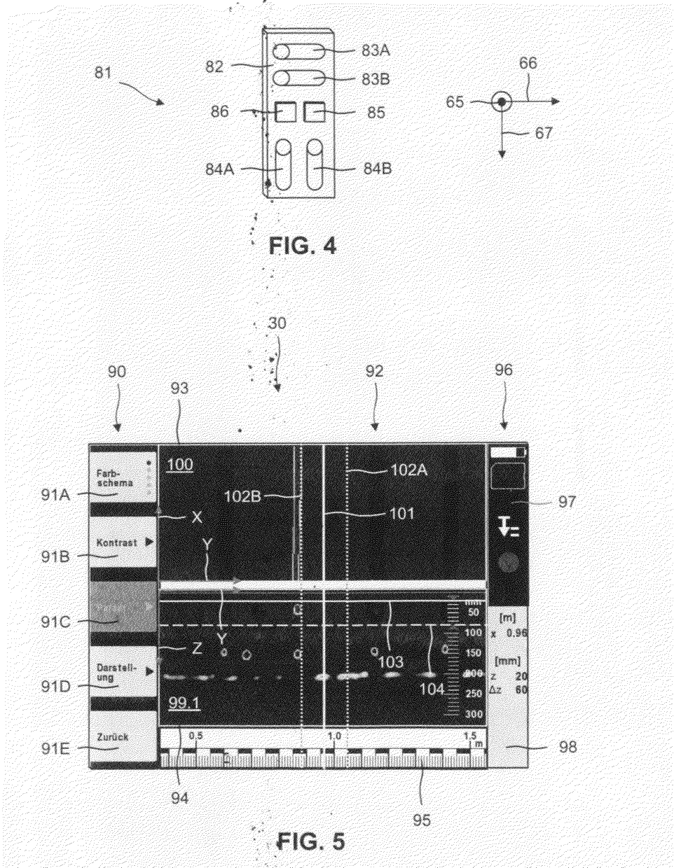

FIG. 5 shows the display 30 of the display unit 26 with a measurement of the detection device 21, which is moved in a linear motion along the travel direction 28 over the underground. The width of the measurement in the X-direction is limited to the width of the detection field. The width of the detection field is displayed to the user via the upper and lower markers 38A, 38B, 39A, 39B on the housing 22 of the detection device 21.

The display 30 is divided during the display of the measurement in a first operating mode into three primary fields: at the left edge of the display 30 a menu of functions is shown in a first primary field 90, which includes up to five functions 91A-91E. Each function 91A-91E is activated by the functional button 36A-36E, located at the left, of the second operating unit 31B. A second primary field 92 is arranged in the central area of the display 30 and serves to display the measurement. The second primary field 92 is divided into three partial fields, which are arranged underneath each other. In an upper partial field 93 a top view is shown, in a central partial field 94 a depth cross section, and in a bottom partial field 95 an allocated measuring scale. At the right edge of the display 30, in a third primary field 96, various data are displayed for the user. The third primary field 96 is divided into an upper status area 97 and a lower information area 98. The status area 97 includes, among other things, information concerning the charge status of the power supply 48 or a memory card, with the information being displayed in the form of pictograms in the status area 97. In the information area 98 updated coordinates of the measurement are shown.

A depth cross section is a two-dimensional display of the measurements in a level extending perpendicular in reference to the XY-level; the depth direction is displayed on the vertical axis of the depth cross section and a horizontal direction in the XY-level on the horizontal axis. In a linear travel motion the horizontal direction is particularly equivalent to the travel direction; in a hand-held detection device or the motion of a hand-held detection device along an arbitrary path, the horizontal direction is particularly equivalent to a travel direction determined by the detection device, for example, a housing edge. In the depth cross section, raw data, e.g., the received signals embodied as hyperboles, or received processed signals are shown. The received signals are processed using image processing and sample detection methods in order to gain information regarding objects in the underground. In depth cross sections using received processed signals the objects are shown geometrically as objects; the shape and size of the objects is displayed by different colors.

A top view represents a two-dimensional illustration of the measurements in the XY-level, calculated from the depth cross sections as averages, medians, maximums, weighed totals, or other suitable mathematical functions regarding the depth range between a first and a second depth. The depth range is determined via the first and second depth or by a layer depth and a layer thickness. The depth range, by which the top view is averaged, is embodied adjustable via the toggle switch 33 of the first operating unit 31A. In the top view only those objects are shown located within the adjusted depth range. All other objects located outside the set depth range are not shown in the top view.

The average partial range 94 shows a first depth cross section 99.1, in which the objects were identified in the underground by detection patterns; a power line is discernible in the cross section. The depth cross section is stretched from the depth direction Z as a vertical axis and the travel direction 28 as a horizontal axis. In addition to the first depth cross section 99.1 additional depth cross sections 99.2-99.5 are stored. The transition between the depth cross sections 99.1-99.5 remains unprocessed or is interpolated using interpolation methods known per se. The operator can switch back and forth via the toggle switch 33 between the depth cross sections 99.1-99.5.

The upper partial field 93 shows a top view 100, which was calculated from the depth cross sections 99.1-99.5 over a depth range between a first depth z and a second depth z+Δz. The power line has been detected in the received signals via pattern detection methods and displayed as a power line in the top view 100. The operator can select from several color schemes to display in color the depth cross sections 99.1-99.5 and the top view 100. The color schemes serve for a differentiated display and to adjust to the ambient brightness; they have no other function.

In the second primary field 92 of the display 30 several vertical and horizontal marking lines are arranged, partially displaceable via the toggle switch 33. FIG. 5 shows a continuous, vertical marking line 101, two dotted, vertical marking lines 102A, 102B, as well as a continuous and a dot-dash, horizontal marking line 103, 104. The continuous, vertical marking line 101 characterizes the center of the detection field and is equivalent to the position of the markings 40A, 40B at the upper and lower edge of the housing 22. The dotted, vertical marking line 102A shows the right hosing edge and the dotted, vertical marking line 102B the left housing edge of the housing 22 of the detection device 21. The continuous horizontal marking line 103 defines the layer depth z and the dot-dash horizontal marking line 104 the layer thickness Δz of the depth range. The top view 100 shown in FIG. 5 is averaged over the depth range from 20 mm to 80 mm, the layer depth z amounts to 20 mm, and the layer thickness Δz amounts to 60 mm. The center of the detection field is located at the X-coordinate 0.96 m.

The measurement shown in FIG. 5 with the depth cross section 99.1 and the top view 100 is a joint measurement of the first and second sensor unit 44, 45. Using the power sensor unit 44 described in FIG. 3A the spatial arrangement of a power line in the underground can be determined; the power sensor unit 44 is not suitable for determining the depth, though, at which the power line is embedded in the underground. When the measurement of the power sensor unit 44 is shown as a separate measurement, the control and evaluation unit 46 calculates an XY-illustration (an XY-cross section) and transmits this XY-illustration to the display unit 26.

By the combination of the power sensor unit 44 with the second sensor unit 45 the measurements of both sensor units 44, 45 can be displayed as joint measurements with depth cross sections and a top view.

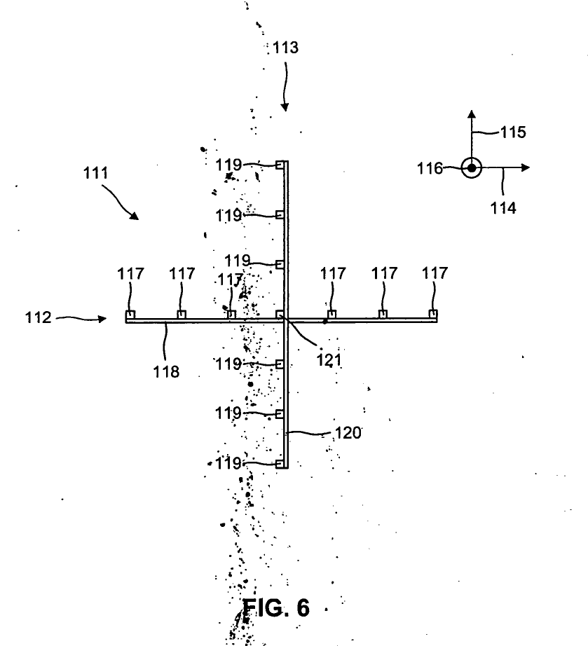

In a schematic illustration FIG. 6 shows another embodiment of a power sensor unit 111, which is suitable, among other things, for the use in a hand-held detection device or a detection device guided along an arbitrary track. The power sensor unit 111 includes a first power sensor unit 112 and a second power sensor unit 113, which are aligned in two horizontal directions 114, 115 perpendicular in reference to each other. The depth direction 116 is defined as the vertical direction into the underground perpendicular in reference to the horizontal directions 94, 95.

The first power sensor unit 112 includes six magnetic field sensor elements 117, arranged on a first holding element 118. The magnetic field sensor elements 117 include a magnetic field gradient in the first horizontal direction 114 and in the depth direction 116. The second power sensor unit 113 includes three magnetic field sensor elements 119, mounted on a second fastening element 120. The magnetic field sensor elements 119 include a magnetic field gradient in the second horizontal direction 115 and in the depth direction 116. The power sensor units 112, 113 include another magnetic field sensor element 121, which detects a magnetic field gradient in the first horizontal direction 114, the second horizontal direction 115, and the depth direction 116. The magnetic field sensor element 121 is fastened on the first and/or the second fastening element 118, 120. In order to eliminate any homogenous magnetic unidirectional fields the magnetic field sensor elements 117, 119, 121 are embodied as gradient sensor elements.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A device for detecting a power line in the underground, comprising:
a sensor unit includes a magnetic field sensor element that is configured to receive a received signal based on the characteristics of the power line and the underground;
a control and processing unit configured to control the sensor unit and to process the received signal; and
a display unit configured to display the received signal processed by the control and processing unit,
wherein the sensor unit includes at least one additional magnetic field sensor unit configured to receive the received signal dependent on the characteristics of the power line and the underground, wherein the magnetic field sensor elements are configured to be controlled independently by the control and processing unit.

2. A device according to claim 1, wherein the sensor unit includes first magnetic field sensor elements and second magnetic field sensor elements, wherein the first magnetic field sensor elements are configured to detect a first magnetic field or a first magnetic field gradient in a first direction, and wherein the second magnetic field sensor elements are configured to detect a second magnetic field or a second magnetic field gradient in a second direction that is different from the first direction.

3. A device according to claim 2, wherein the first magnetic field sensor elements and the second magnetic field sensor elements are arranged alternatingly along a horizontal direction.

4. A device according to claim 2, wherein the sensor unit includes third magnetic field sensor elements that are configured to detect a third magnetic field or a third magnetic field gradient in a third direction that is different from the first direction and the second direction.

5. A device according to claim 1, wherein the magnetic field sensor elements are configured to detect a magnetic field or a magnetic field gradient in a first direction and in a second direction that is different from the first direction.

6. A device according to claim 5, wherein the magnetic field sensor elements are configured to detect the magnetic field or the magnetic field gradient in a third direction that is different from the first direction and the second direction.

7. A device according to claim 1, wherein the magnetic field sensor elements include two magnetic field sensors each, arranged in parallel and spaced with respect to each other.

8. A device according to claim 1, comprising a modulation unit coupled, via a communication connection, to a control and evaluation unit and coupled with a power signal of the power line, wherein the power signal is modulated based on a control command of the control and evaluation unit.

9. A device according to claim 8, wherein the control and evaluation unit includes an evaluation module that demodulates the received signals.

10. A device according to claim 1, comprising another sensor unit is provided to detect an object in the underground.

11. A method for detecting a power line in an underground, comprising:
detecting a received signal by a magnetic field sensor of a sensor unit;
evaluating the received signal by a control and evaluation unit;
displaying the evaluated received signals on a display unit; and
detecting at least one additional received signal by another magnetic field sensor element of the sensor unit.

12. A method according to claim 11, wherein a first magnetic field gradient is detected in a first direction and a second magnetic field gradient is detected in a second direction.

13. A method according to claim 12, wherein the sensor unit is moved in a travel direction over the underground, wherein the first magnetic field gradient is detected in a horizontal direction that is perpendicular with respect to the travel direction, and wherein the second magnetic field gradient is detected in a depth direction that is perpendicular with respect to the travel direction and the horizontal direction.

14. A method according to claim 13, wherein first magnetic field sensor elements and second magnetic field sensor elements are arranged alternatingly in the horizontal direction, and wherein, from the first magnetic field gradient and the second magnetic field gradient, each an average amount is calculated from the first magnetic field sensor elements and the second magnetic field sensor elements.

15. A method according to claim 14, wherein, from the averages of the first magnetic field sensor elements and the second magnetic field sensor elements, a horizontal calculation is calculated by the control and evaluation unit and transmitted by the control and evaluation unit to a display unit for display.

16. A method according to one of claims 15, wherein additional received signals are received by sensor elements of another sensor unit.

17. A method according to claim 16, wherein, from the received signals of the sensor unit and the received signals of the additional sensor unit, joint depth cross section images are calculated by the control and evaluation unit and a joint top view is calculated from the joint depth cross sections.

18. A method according to claim 16, wherein, from the received signals of the sensor unit and the received signals of the additional sensor unit, separate depth cross sections are calculated by the control and evaluation unit and separate top views are calculated from the separate depth cross sections.
